(19) United States
(12) Patent Application Publication
(10) Pub. No.: US 2026/0175799 A1
(43) Pub. Date: Jun. 25, 2026

(54) VEHICLE

(71) Applicant: YAMAHA HATSUDOKI KABUSHIKI KAISHA, Iwata-shi (JP)

(72) Inventors: Kohki TSUJIMURA, Shizuoka (JP); Koki KAWAI, Shizuoka (JP)

(21) Appl. No.: 19/416,431

(22) Filed: Dec. 11, 2025

(30) Foreign Application Priority Data
Dec. 24, 2024 (JP) 2024-227803

(51) Int. Cl. B60R 16/02; B60K 1/00; B60K 1/04; B60R 16/08

(52) U.S. Cl. CPC B60R 16/0215; B60K 1/04; B60R 16/08; B60K 2001/005; B60K 2001/006; B60K 2001/0438

(57) ABSTRACT

A vehicle includes an electrical device, a high-voltage electrical wire connected to the electrical device, and a water pipe through which coolant flows to cool the electrical device. A predetermined portion of the water pipe and the high-voltage electrical wire are spaced apart from each other by at least a first predetermined distance.

### CROSS-REFERENCE TO RELATED APPLICATIONS

The present application claims priority to Japanese Patent Application No. 2024-227803 filed on Dec. 24, 2024, the entire contents of which are hereby incorporated herein by reference.

### BACKGROUND OF THE INVENTION

### 1. Field of the Invention

The present invention relates to vehicles.

### 2. Description of the Related Art

Vehicles having electrical wires and water pipes have been known in the art. For example, JP 6543604 B describes a vehicle having a drive motor, high-voltage electrical wires for supplying power to the motor, and the like, and water pipes through which coolant flows to cool the motor, and the like.

JP 6543604 B states that because the DC-DC converter and the high-voltage electrical wires are spaced away from a plurality of water pipes arranged on one side of a battery unit in the vehicle width direction, the DC-DC converter and the high-voltage wires can be protected from water from the plurality of water pipes.

### SUMMARY OF THE INVENTION

Now, mechanics or users with maintenance skills, when maintaining or repairing vehicle components to be cooled, such as the motor, or when maintaining or repairing water pipes, the water pipes are removed from the components to be cooled. At this time, the mechanics or users need to pay attention to prevent water from the removed water pipes or components to be cooled from splashing onto the high-voltage electrical wires, which has created a significant work burden.

Example embodiments of the present invention reduce the work burden when maintaining or repairing water pipes of vehicles.

A vehicle according to an example embodiment of the present invention includes an electrical device, a high-voltage electrical wire connected to the electrical device, and a water pipe through which coolant flows to cool the electrical device. A predetermined portion of the water pipe and the high-voltage electrical wire are spaced apart from each other by at least a first predetermined distance.

The electrical device may include a joint to which the water pipe is detachably connected. The joint and the high-voltage electrical wire may be spaced apart from each other by at least the first predetermined distance.

With the vehicle described above, since the predetermined portion of the water pipe and the high-voltage electrical wire are spaced apart from each other by at least the first predetermined distance, or the joint and the high-voltage electrical wire are spaced apart from each other by at least the first predetermined distance, water is less likely to splash onto the high-voltage electrical wire from the water pipe when, for example, the water pipe is removed from the joint for maintaining or repairing the water pipe. Since water is less likely to splash onto the high-voltage electrical wire, the work burden for mechanics or users when maintaining or repairing the water pipe is reduced.

The first predetermined distance may be about 150 mm, for example.

Thus, since the predetermined portion of the water pipe or the joint and the high-voltage electrical wire are sufficiently spaced apart from each other, water is less likely to splash onto the high-voltage electrical wire.

The predetermined portion of the water pipe or the joint and the high-voltage electrical wire may be spaced apart from each other in a vehicle left-right direction.

For example, even if water spills when the water pipe is removed from the joint, the water falls downward. Accordingly, since the predetermined portion of the water pipe or the joint and the high-voltage electrical wire are spaced apart from each other in the vehicle left-right direction, it is possible to more reliably prevent water from splashing onto the high-voltage electrical wire.

The predetermined portion of the water pipe or the joint and the high-voltage electrical wire may be spaced apart from each other by at least a second predetermined distance in a vehicle left-right direction.

Thus, since the predetermined portion of the water pipe or the joint and the high-voltage electrical wire are spaced apart from each other in the vehicle left-right direction, water is less likely to splash onto the high-voltage electrical wire.

The water pipe may include a first pipe portion extending in a vehicle front-rear direction. The high-voltage electrical wire may include a first wire portion extending in the vehicle front-rear direction. A vehicle component may be located between the first pipe portion and the first wire portion in the vehicle left-right direction.

Thus, even if water leaks from the first pipe portion, since the vehicle component is located between the first pipe portion and the first wire portion, water is less likely to splash onto the first wire portion.

The vehicle component may include a battery.

The predetermined portion of the water pipe or the joint and the high-voltage electrical wire may be spaced apart from each other by at least a second predetermined distance in a vehicle left-right direction and spaced apart from each other by at least a third predetermined distance in a vehicle up-down direction.

The predetermined portion of the water pipe or the joint may be located below the high-voltage electrical wire in a vehicle up-down direction.

Thus, even if water spills from the joint or the water pipe when the water pipe is removed from the joint, for example, water is less likely to splash onto the high-voltage electrical wire since the high-voltage electrical wire is located higher than the joint.

At least 60% of the water pipe and at least 60% of the high-voltage electrical wire may be spaced apart from each other by at least the first predetermined distance.

At least 60% of the water pipe and at least 60% of the high-voltage electrical wire may be spaced apart from each other by at least a second predetermined distance in a vehicle left-right direction.

The electrical device may include at least one drive motor.

The vehicle may further include a pair of left and right front wheels, and a pair of left and right rear wheels. The electrical device may include a front motor connected to the pair of left and right front wheels to drive the pair of left and right front wheels, and a rear motor connected to the pair of left and right rear wheels to drive the pair of left and right rear wheels. The front motor may include a first joint detachably connected to the water pipe. The rear motor may include a second joint detachably connected to the water pipe. The high-voltage electrical wire may be located one of leftward or rightward of a vehicle center line, and the first joint and the second joint may be located on the other one of leftward or rightward of the vehicle center line.

The electrical device may include a central battery that overlaps with a vehicle center line when the vehicle is seen from above, a left-side battery located leftward of the central battery in a vehicle left-right direction, and a right-side battery located rightward of the central battery in the vehicle left-right direction. The vehicle may include a central connector to connects the central battery and the high-voltage electrical wire. The water pipe may be located one of leftward or rightward of the central battery, and the central connector may be located the other one of leftward or rightward of the central battery.

According to example embodiments of the present invention, it is possible to reduce the work burden when maintaining or repairing water pipes of vehicles.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view of a vehicle according to an example embodiment of the present invention.

FIG. 2 is a perspective view of some components of the vehicle.

FIG. 3 is a plan view of some components of the vehicle.

FIG. 4 is a bottom view of some components of the vehicle.

FIG. 5 is a left side view of some components of the vehicle.

FIG. 6 is a right side view of some components of the vehicle.

### DETAILED DESCRIPTION OF THE EXAMPLE EMBODIMENTS

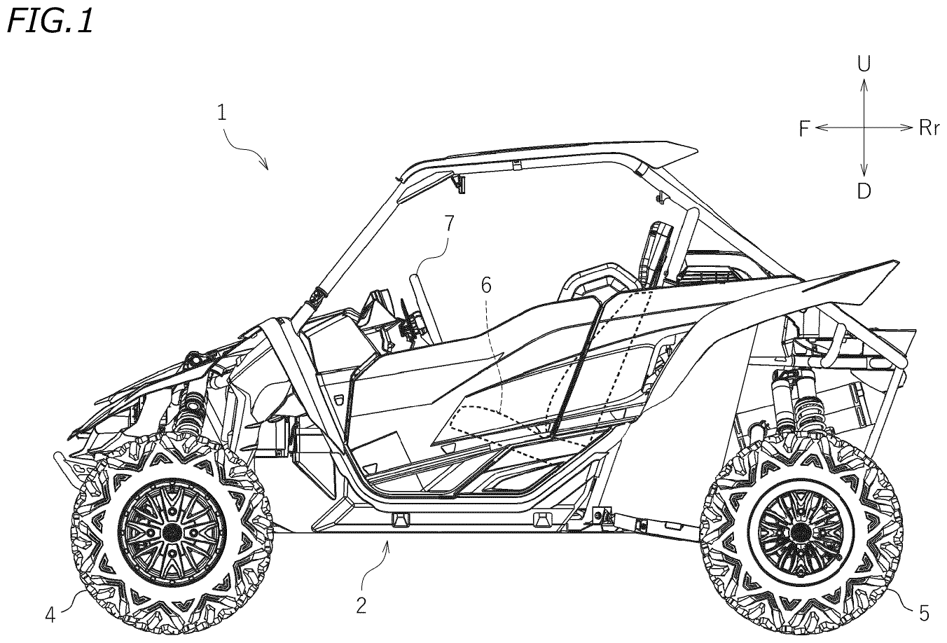

Example embodiments of the present invention will now be described with reference to FIG. 1. In the following description, designations F, Rr, L, R, U, and D in the figures represent front, rear, left, right, up, and down, respectively.

As shown in FIG. 1, a vehicle 1 according to an example embodiment of the present invention is a vehicle capable of running on uneven terrains, for example, a so-called ROV (Recreational Off-highway Vehicle). An ROV is a four-wheeled vehicle including a plurality of seats 6 arranged side by side in the vehicle width direction, and a steering wheel 7. However, the type of vehicle is not limited to ROVs. For example, the vehicle may be a straddled four-wheeled vehicle including a steering bar, such as an ATV (All Terrain Vehicle). The vehicle may also be a vehicle other than an ROV or ATV. The vehicle 1 includes a vehicle body frame 2, a pair of left and right front wheels 4 supporting the vehicle body frame 2, and a pair of left and right rear wheels 5 supporting the vehicle body frame 2.

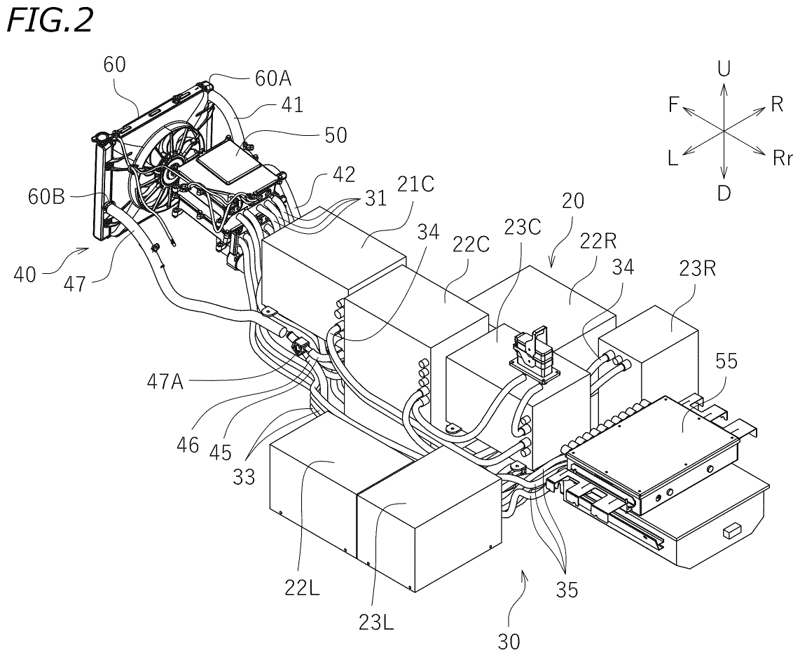

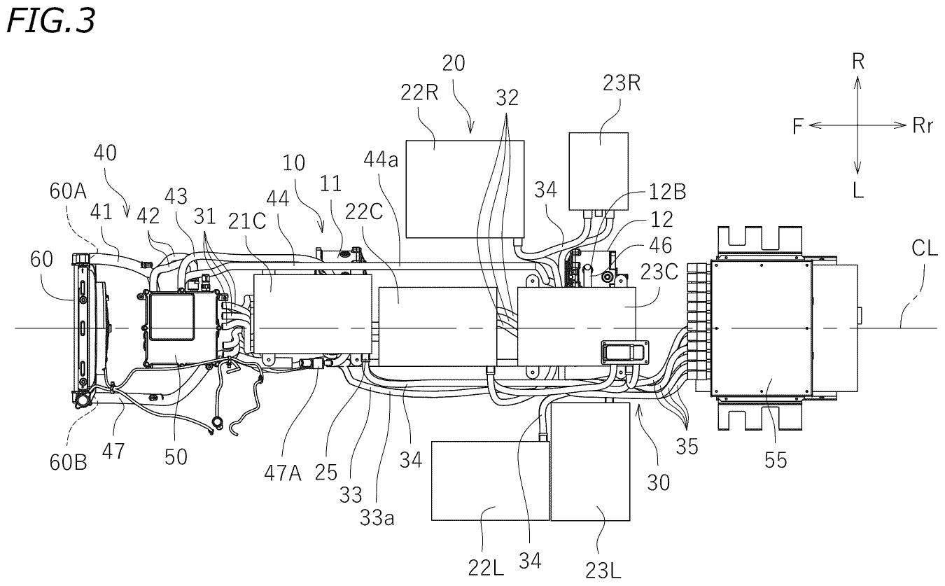

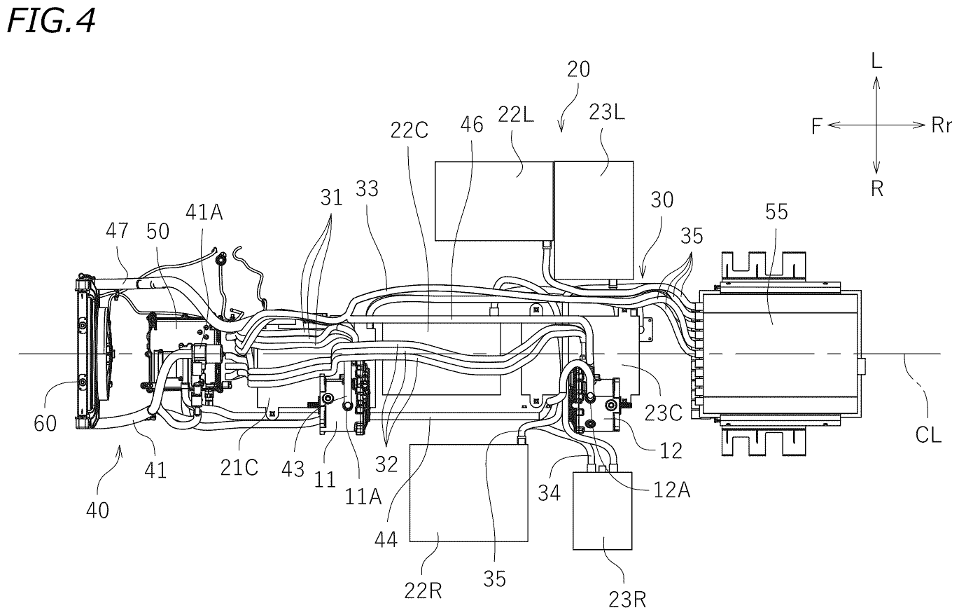

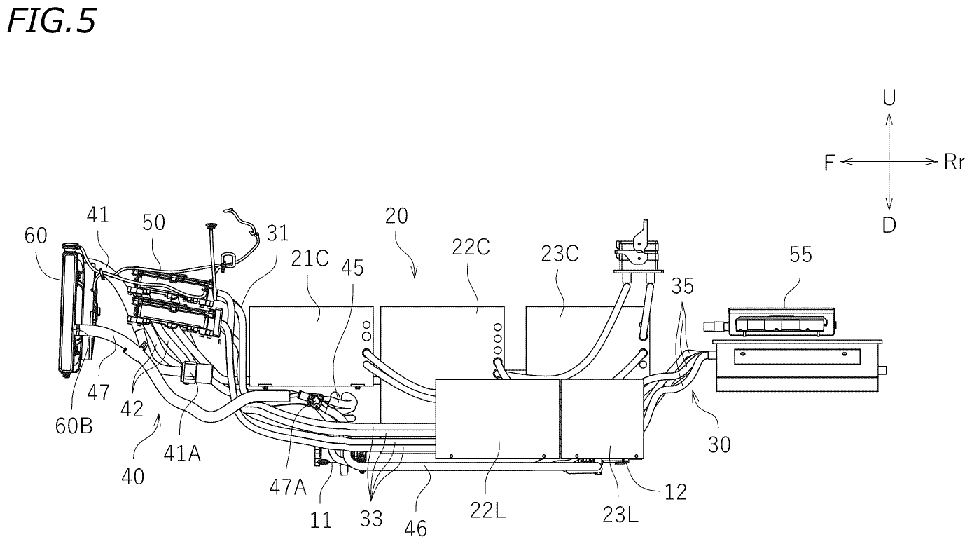

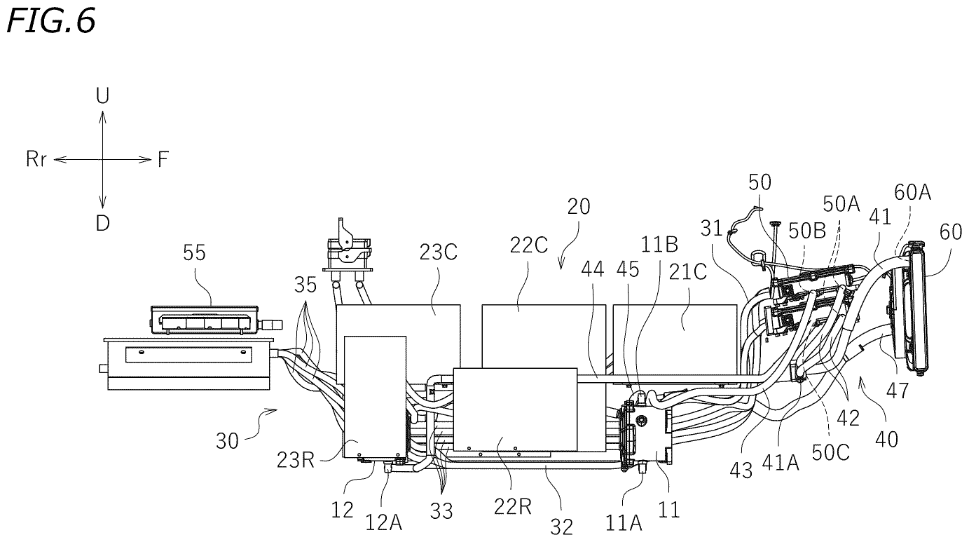

FIG. 2 is a perspective view showing some selected components of the vehicle 1. FIG. 3, FIG. 4, FIG. 5, and FIG. 6 are a plan view, a bottom view, a left side view, and a right side view, respectively, of the selected components. The vehicle 1 may be a so-called electric vehicle. As described more specifically below, the vehicle 1 includes a drive motor, a group of batteries 20, a group of high-voltage electrical wires 30 connected to the drive motor and the group of batteries 20, and a group of water pipes 40 through which coolant flows.

As shown in FIG. 4, the vehicle 1 includes a front motor 11 and a rear motor 12 as drive motors. The front motor 11 is connected to the front wheels 4 via a drive shaft (not shown). The front motor 11 is configured to drive the front wheels 4. The rear motor 12 is connected to the rear wheels 5 via a drive shaft (not shown). The rear motor 12 is configured to drive the rear wheels 5.

As shown in FIG. 3, the group of batteries 20 includes batteries 21C, 22C, 23C, 22L, 23L, 22R, and 23R. The vehicle 1 includes central batteries 21C, 22C, and 23C, which overlap with the vehicle center line CL when the vehicle is seen from above, left-side batteries 22L and 23L located leftward of the central batteries 21C, 22C, and 23C, and right-side batteries 22R and 23R located rightward of the central batteries 21C, 22C, and 23C. The central battery 21C is located forward of the central battery 22C, and the central battery 23C is located rearward of the central battery 22C. The left-side battery 23L is located rearward of the left-side battery 22L. The right-side battery 23R is located rearward of the right-side battery 22R. While there is no particular limitation, in the present example embodiment, the group of batteries 20 are located rearward of the center of the front wheels 4 and forward of the center of the rear wheels 5. The group of batteries 20 may also be located rearward of the rear end of the front wheels 4 and forward of the front end of the rear wheels 5.

As shown in FIG. 3, the vehicle 1 includes a controller 55 including, for example, ECUs (Electric Control Units), and an inverter 50. While there is no particular limitation on the location of the controller 55 and the inverter 50, in the present example embodiment, the controller 55 is located rearward of the group of batteries 20, and the inverter 50 is located forward of the group of batteries 20. The controller 55 and the inverter 50 overlap with the vehicle center line CL when the vehicle is seen from above.

The group of high-voltage electrical wires 30 includes high-voltage electrical wires 31 to 35. The vehicle 1 includes a plurality of high-voltage electrical wires 31 to 35. A “high-voltage electrical wire” as used herein refers to an electrical wire carrying a voltage of, for example, about 60 V or higher for direct current or, for example, about 30 V or higher for alternating current.

As shown in FIG. 3 and FIG. 4, the front motor 11 and the inverter 50 are connected by the high-voltage electrical wires 31. The rear motor 12 and the inverter 50 are connected by the high-voltage electrical wires 32. The front motor 11 and the rear motor 12 may be so-called three-phase motors. There are provided three each of the high-voltage electrical wires 31 and the high-voltage electrical wires 32. The controller 55 and the inverter 50 are connected by a plurality of high-voltage electrical wires 33. The batteries within the group of batteries 20 are connected by the high-voltage electrical wires 34. The group of batteries 20 and the controller 55 are connected by the high-voltage electrical wires 35. The front motor 11 and the rear motor 12 are configured to be powered by the group of batteries 20.

As shown in FIG. 3, the vehicle 1 includes a radiator 60 for cooling coolant. While there is no particular limitation on the location of the radiator 60, in the present example embodiment, the radiator 60 is located forward of the inverter 50.

The vehicle 1 includes the group of water pipes 40 through which coolant flows. Coolant cools the inverter 50, the front motor 11, and the rear motor 12. The group of water pipes 40 includes water pipes to be described below. Note that a “water pipe” only needs to be able to allow coolant to pass therethrough, and there is no particular limitation on the specific configuration thereof. A “water pipe” may, for example, be a pipe made of metal or the like, or may be a flexible hose.

As shown in FIG. 6, the radiator 60 and the inverter 50 are connected by water pipes 41 and 42. The water pipe 41 and the water pipe 42 are connected by a coupling 41A. The radiator 60 includes a joint 60A to which the water pipe 41 is detachably connected. The inverter 50 includes a joint 50A to which the water pipe 42 is detachably connected. Note that a “joint” as used herein only needs to be capable of connecting water pipes, and there is no limitation on the specific configuration thereof. A “joint” may, for example, be a tubular body into which a water pipe is inserted.

The inverter 50 and the front motor 11 are connected by a water pipe 43. The inverter 50 includes a joint 50B to which the water pipe 43 is detachably connected. The front motor 11 includes a joint 11A to which the water pipe 43 is detachably connected.

The inverter 50 and the rear motor 12 are connected by a water pipe 44. The inverter 50 includes a joint 50C to which the water pipe 44 is detachably connected. The rear motor 12 includes a joint 12A to which the water pipe 44 is detachably connected.

As shown in FIG. 5 and FIG. 6, the front motor 11 and the radiator 60 are connected by water pipes 45 and 47. As shown in FIG. 3 and FIG. 4, the rear motor 12 and the radiator 60 are connected by water pipes 46 and 47. The water pipe 45, the water pipe 46, and the water pipe 47 are connected by a coupling 47A (see FIG. 2). As shown in FIG. 6, the front motor 11 includes a joint 11B to which the water pipe 45 is detachably connected. As shown in FIG. 3, the rear motor 12 includes a joint 12B to which the water pipe 46 is detachably connected. As shown in FIG. 5, the radiator 60 includes a joint 60B to which the water pipe 47 is detachably connected.

In the present example embodiment, at least 60% of the group of water pipes 40 is located rightward of the vehicle center line CL, and at least 60% of the group of high-voltage electrical wires 30 is located leftward of the vehicle center line CL (see FIG. 3). The at least 60% of the group of water pipes 40 and the at least 60% of the group of high-voltage electrical wires 30 are spaced apart from each other by, for example, at least about 100 mm (the second predetermined distance) in the left-right direction.

A portion of the group of water pipes 40 and a portion of the group of high-voltage electrical wires 30 are spaced apart from each other in the left-right direction and the up-down direction. In the present example embodiment, the at least 60% of the group of water pipes 40 and the at least 60% of the group of high-voltage electrical wires 30 are spaced apart from each other by at least about 150 mm (the first predetermined distance), for example.

At least one of the joints 11A, 11B, 12A, and 12B of the front motor 11 and the rear motor 12 is spaced apart from at least a portion of the group of high-voltage electrical wires 30 by at least the first predetermined distance. In the present example embodiment, the first distance is about 150 mm, for example. As an example of the predetermined portion of a water pipe, the group of water pipes 40 each include a portion that is connected to at least one of the joints 11A, 11B, 12A, and 12B. The predetermined portion of the water pipe and at least a portion of the group of high-voltage electrical wires 30 are spaced apart from each other by at least the first distance.

Here, in a cross section that extends through the joint 11A (specifically, the center of the joint 11A) and is perpendicular to the vehicle center line CL (hereinafter referred to as the vehicle cross section at the joint 11A), the joint 11A and the high-voltage electrical wires 33 are spaced apart from each other by at least the first predetermined distance (see FIG. 4). In the vehicle cross section at the joint 11A, the joint 11A and at least one of the high-voltage electrical wires 31, 32, 34, and 35 may be spaced apart from each other by at least the first predetermined distance. In a cross section that extends through a portion of the water pipe 43 connected to the joint 11A (the predetermined portion) and is perpendicular to the vehicle center line CL (hereinafter referred to as the vehicle cross section at the predetermined portion of the water pipe), the predetermined portion of the water pipe 43 and the high-voltage electrical wires 33 are spaced apart from each other by at least the first predetermined distance. In the vehicle cross section at the predetermined portion of the water pipe, the predetermined portion of the water pipe 43 and at least one of the high-voltage electrical wires 31, 32, 34, and 35 are spaced apart from each other by at least the first predetermined distance.

In the vehicle cross section at the joint 11A, the joint 11A and the high-voltage electrical wires 31, 32, and 33 are spaced apart from each other in the left-right direction. Here, in the vehicle cross section at the joint 11A, the joint 11A and the high-voltage electrical wires 33 are spaced apart from each other by at least the second predetermined distance in the left-right direction. In the vehicle cross section at the joint 11A, the joint 11A and the high-voltage electrical wires 33 are spaced apart from each other by at least the third predetermined distance in the up-down direction. In the present example embodiment, the second predetermined distance is about 100 mm, for example, and the third predetermined distance is about 100 mm, for example. In the vehicle cross section at the joint 11A, the joint 11A and the high-voltage electrical wires 31 or 32 may be spaced apart from each other by at least the second predetermined distance in the left-right direction and may be spaced apart from each other by at least the third predetermined distance in the up-down direction.

In the vehicle cross section at the joint 11A, the portion of the water pipe 43 connected to the joint 11A and the high-voltage electrical wires 31, 32, and 33 are spaced apart from each other in the left-right direction. Here, in the vehicle cross section at the joint 11A, the portion of the water pipe 43 connected to the joint 11A and the high-voltage electrical wires 33 are spaced apart from each other by at least the second predetermined distance in the left-right direction. In the vehicle cross section at the joint 11A, the portion of the water pipe 43 connected to the joint 11A and the high-voltage electrical wires 33 are spaced apart from each other by at least the third predetermined distance in the up-down direction. In the vehicle cross section at the joint 11A, the portion of the water pipe 43 connected to the joint 11A and the high-voltage electrical wires 31 or 32 may be spaced apart from each other by at least the second predetermined distance in the left-right direction and may be spaced apart from each other by at least the third predetermined distance in the up-down direction.

In a cross section that extends through the joint 11B (specifically, the center of the joint 11B) and is perpendicular to the vehicle center line CL (hereinafter referred to as the vehicle cross section at the joint 11B), the joint 11B and the high-voltage electrical wires 33 are spaced apart from each other by at least the first predetermined distance. In the vehicle cross section at the joint 11B, the joint 11B and at least one of the high-voltage electrical wires 31, 32, 34, and 35 may be spaced apart from each other by at least the first predetermined distance.

In the cross section that extends through the joint 11B (specifically, the center of the joint 11B) and is perpendicular to the vehicle center line CL (hereinafter referred to as the vehicle cross section at the joint 11B), the portion of the water pipe 45 connected to the joint 11B and the high-voltage electrical wires 33 are spaced apart from each other by at least the first predetermined distance. In the vehicle cross section at the joint 11B, the portion of the water pipe 45 connected to the joint 11B and at least one of the high-voltage electrical wires 31, 32, 34, and 35 may be spaced apart from each other by at least the first predetermined distance.

In the vehicle cross section at the joint 11B, the joint 11B and the high-voltage electrical wires 31, 32, and 33 are spaced apart from each other in the left-right direction. Here, in the vehicle cross section at the joint 11B, the joint 11B and the high-voltage electrical wires 33 are spaced apart from each other by at least the second predetermined distance in the left-right direction. In the vehicle cross section at the joint 11B, the joint 11B and the high-voltage electrical wires 33 are spaced apart from each other by at least the third predetermined distance in the up-down direction. In the vehicle cross section at the joint 11B, the joint 11B and the high-voltage electrical wires 31 or 32 may be spaced apart from each other by at least the second predetermined distance in the left-right direction and may be spaced apart from each other by at least the third predetermined distance in the up-down direction.

In the vehicle cross section at the joint 11B, the portion of the water pipe 45 connected to the joint 11B and the high-voltage electrical wires 31, 32, and 33 are spaced apart from each other in the left-right direction. Here, in the vehicle cross section at the joint 11B, the portion of the water pipe 45 to which the joint 11B is connected and the high-voltage electrical wires 33 are spaced apart from each other by at least the second predetermined distance in the left-right direction. In the vehicle cross section at the joint 11B, the portion of the water pipe 45 to which the joint 11B is connected and the high-voltage electrical wires 33 are spaced apart from each other by at least the third predetermined distance in the up-down direction. In the vehicle cross section at the joint 11B, the portion of the water pipe 45 to which the joint 11B is connected and the high-voltage electrical wires 31 or 32 may be spaced apart from each other by at least the second predetermined distance in the left-right direction and may be spaced apart from each other by at least the third predetermined distance in the up-down direction.

In a cross section that extends through the joint 12A (specifically, the center of the joint 12A) and is perpendicular to the vehicle center line CL (hereinafter referred to as the vehicle cross section at the joint 12A), the joint 12A and the high-voltage electrical wires 33 are spaced apart from each other by at least the first predetermined distance. In the vehicle cross section at the joint 12A, the joint 12A and at least one of the high-voltage electrical wires 31, 32, 34, and 35 may be spaced apart from each other by at least the first predetermined distance.

In the vehicle cross section at the joint 12A, the portion of the water pipe 44 to which the joint 12A is connected and the high-voltage electrical wires 33 are spaced apart from each other by at least the first predetermined distance. In the vehicle cross section at the joint 12A, the portion of the water pipe 44 to which the joint 12A is connected and at least one of the high-voltage electrical wires 31, 32, 34, and 35 may be spaced apart from each other by at least the first predetermined distance.

In the vehicle cross section at the joint 12A, the joint 12A and the high-voltage electrical wires 33, 34, and 35 are spaced apart from each other in the left-right direction. Here, in the vehicle cross section at the joint 12A, the joint 12A and the high-voltage electrical wires 33 are spaced apart from each other by at least the second predetermined distance in the left-right direction. In the vehicle cross section at the joint 12A, the joint 12A and the high-voltage electrical wires 33 are spaced apart from each other by at least the third predetermined distance in the up-down direction. In the vehicle cross section at the joint 12A, the joint 12A and the high-voltage electrical wires 34 or 35 may be spaced apart from each other by at least the second predetermined distance in the left-right direction and may be spaced apart from each other by at least the third predetermined distance in the up-down direction.

In the vehicle cross section at the joint 12A, the portion of the water pipe 44 to which the joint 12A is connected and the high-voltage electrical wires 33, 34, and 35 are spaced apart from each other in the left-right direction. Here, in the vehicle cross section at the joint 12A, the portion of the water pipe 44 to which the joint 12A is connected and the high-voltage electrical wires 33 are spaced apart from each other by at least the second predetermined distance in the left-right direction. In the vehicle cross section at the joint 12A, the portion of the water pipe 44 to which the joint 12A is connected and the high-voltage electrical wires 33 are spaced apart from each other by at least the third predetermined distance in the up-down direction. In the vehicle cross section at the joint 12A, the portion of the water pipe 44 to which the joint 12A is connected and the high-voltage electrical wires 34 or 35 may be spaced apart from each other by at least the second predetermined distance in the left-right direction and may be spaced apart from each other by at least the third predetermined distance in the up-down direction.

In a cross section that passes through the joint 12B (specifically, the center of the joint 12B) and is perpendicular to the vehicle center line CL (hereinafter referred to as the vehicle cross section at the joint 12B), the joint 12B and the high-voltage electrical wires 33 are spaced apart from each other by at least the first predetermined distance. In the vehicle cross section at the joint 12B, the joint 12B and at least one of the high-voltage electrical wires 31, 32, 34, and 35 may be spaced apart from each other by at least the first predetermined distance.

In the vehicle cross section at the joint 12B, the portion of the water pipe 46 to which the joint 12B is connected and the high-voltage electrical wires 33 are spaced apart from each other by at least the first predetermined distance. In the vehicle cross section at the joint 12B, the portion of the water pipe 46 to which the joint 12B is connected and at least one of the high-voltage electrical wires 31, 32, 34, and 35 may be spaced apart from each other by at least the first predetermined distance.

In the vehicle cross section at the joint 12B, the joint 12B and the high-voltage electrical wires 33, 34, and 35 are spaced apart from each other in the left-right direction. Here, in the vehicle cross section at the joint 12B, the joint 12B and the high-voltage electrical wires 33 are spaced apart from each other by at least the second predetermined distance in the left-right direction. In the vehicle cross section at the joint 12B, the joint 12B and the high-voltage electrical wires 33 are spaced apart from each other by at least the third predetermined distance in the up-down direction. In the vehicle cross section at the joint 12B, the joint 12B and the high-voltage electrical wires 34 or 35 may be spaced apart from each other by at least the second predetermined distance in the left-right direction and may be spaced apart from each other by at least the third predetermined distance in the up-down direction.

In the vehicle cross section at the joint 12B, the portion of the water pipe 46 to which the joint 12B is connected and the high-voltage electrical wires 33, 34, and 35 are spaced apart from each other in the left-right direction. Here, in the vehicle cross section at the joint 12B, the portion of the water pipe 46 to which the joint 12B is connected and the high-voltage electrical wires 33 are spaced apart from each other by at least the second predetermined distance in the left-right direction. In the vehicle cross section at the joint 12B, the portion of the water pipe 46 to which the joint 12B is connected and the high-voltage electrical wires 33 are spaced apart from each other by at least the third predetermined distance in the up-down direction. In the vehicle cross section at the joint 12B, the portion of the water pipe 46 to which the joint 12B is connected and the high-voltage electrical wires 34 or 35 may be spaced apart from each other by at least the second predetermined distance in the left-right direction and may be spaced apart from each other by at least the third predetermined distance in the up-down direction.

As shown in FIG. 3 and FIG. 4, the joints 11A and 11B of the front motor 11, and the joints 12A and 12B of the rear motor 12, are located rightward of the vehicle center line CL. A portion of the high-voltage electrical wires 31, a portion of the high-voltage electrical wires 32, the entirety of the high-voltage electrical wires 33, a portion of the high-voltage electrical wires 34, and a portion of the high-voltage electrical wires 35 are located leftward of the vehicle center line CL.

As shown in FIG. 3, the central battery 21C includes a central connector 25 that connects to the high-voltage electrical wire 34. The water pipe 44 is located rightward of the central battery 21C, and the central connector 25 is located leftward of the central battery 21C. In the left-right direction, the central battery 21C is located between the water pipe 44 and the central connector 25.

As described above, according to an example embodiment of the present invention, in the cross section that extends through the joint 11A of the front motor 11 and is perpendicular to the vehicle center line CL, the portion of the water pipe 43 to which the joint 11A is connected and the joint 11A are spaced apart from the high-voltage electrical wires 33 by at least the first predetermined distance. Since this portion of the water pipe 43 and the joint 11A are spaced apart from the high-voltage electrical wires 33 by at least the first predetermined distance, water is less likely to splash onto the high-voltage electrical wires 33 from the connecting port (not shown) between the joint 11A and the water pipe 43 when the water pipe 43 is removed from the joint 11A for maintaining or repairing the water pipe 43. Since water is less likely to splash onto the high-voltage electrical wires 33, the work burden for mechanics or users with maintenance skills when maintaining or repairing the water pipe 43 is reduced. Similarly, in the cross section that extends through the joint 11B of the front motor 11 and is perpendicular to the vehicle center line CL, the portion of the water pipe 45 connected to the joint 11B and the joint 11B are spaced apart from the high-voltage electrical wires 33 by at least the first predetermined distance. In the cross section that extends through the joint 12A of the rear motor 12 and is perpendicular to the vehicle center line CL, the portion of the water pipe 44 to which the joint 12A is connected and the joint 12A are spaced apart from the high-voltage electrical wires 33 by at least the first predetermined distance. In the cross section that extends through the joint 12B of the rear motor 12 and is perpendicular to the vehicle center line CL, the portion of the water pipe 46 to which the joint 12B is connected and the joint 12B are spaced apart from the high-voltage electrical wires 33 by at least the first predetermined distance. Water is less likely to splash onto the high-voltage electrical wires 33 when the water pipe 45 is removed from the joint 11B, when the water pipe 44 is removed from the joint 12A, and when the water pipe 46 is removed from the joint 12B. This reduces the work burden for mechanics or users with maintenance skills when maintaining or repairing the water pipes 44, 45, and 46.

While the first predetermined distance may be changed as needed as long as the above effects are achieved, it is preferably set to 150 mm in the present example embodiment. Since the joints 11A, 11B, 12A, and 12B and the high-voltage electrical wires 33 are sufficiently spaced apart from each other, water is less likely to splash onto the high-voltage electrical wires 33.

The joints 11A, 11B, 12A, and 12B and the high-voltage electrical wires 33 are separated from each other in the left-right direction. Even if water spills when the water pipes 43, 45, 44, and 46 are removed from the joints 11A, 11B, 12A, and 12B, the water falls downward. According to an example embodiment, since the joints 11A, 11B, 12A, and 12B and the high-voltage electrical wires 33 are separated from each other in the left-right direction, it is possible to more reliably prevent water from splashing onto the high-voltage electrical wires 33.

The joints 11A, 11B, 12A, and 12B and the high-voltage electrical wires 33 are spaced apart from each other by at least the second predetermined distance in the left-right direction. While the second predetermined distance may be changed as needed as long as the above effects are achieved, it is preferably set to 100 mm in the present example embodiment. Since the joints 11A, 11B, 12A, and 12B and the high-voltage electrical wires 33 are sufficiently distant from each other, water is less likely to splash onto the high-voltage electrical wires 33.

The joints 11A, 11B, 12A, and 12B and the high-voltage electrical wires 33 are spaced apart from each other by at least the second predetermined distance in the left-right direction and are spaced apart from each other by at least the third predetermined distance in the up-down direction. While the third predetermined distance may be changed as needed as long as the above effects are achieved, it is preferably set to 100 mm in the present example embodiment. Since the joints 11A, 11B, 12A, and 12B and the high-voltage electrical wires 33 are sufficiently distant from each other, water is less likely to splash onto the high-voltage electrical wires 33.

The joints 11A and 12A are located below the high-voltage electrical wires 31, 32, 33, 34, and 35. In the vehicle cross section at the joint 11A, the joint 11A is located below the high-voltage electrical wires 33, 34, and 35. In the vehicle cross section at the joint 12A, the joint 12A is located below the high-voltage electrical wires 33, 34, and 35. Even if water spills when the water pipe 43 is removed from the joint 11A or when the water pipe 44 is removed from the joint 12A, water is less likely to splash onto the high-voltage electrical wires 31, 32, 33, 34, and 35 since the high-voltage electrical wires 31, 32, 33, 34, and 35 are located higher than the joints 11A and 12A.

As shown in FIG. 3, the group of water pipes 40 includes a first pipe portion 44a extending in the front-rear direction. The group of high-voltage electrical wires 30 includes a first wire portion 33a extending in the front-rear direction. In the left-right direction, the central battery 22C, which is one of the vehicle components, is located between the first pipe portion 44a and the first wire portion 33a. The central battery 22C is located leftward of the first pipe portion 44a and rightward of the first wire portion 33a. According to the present example embodiment, even if water leaks from the first pipe portion 44a, since the central battery 22C is located between the first pipe portion 44a and the first wire portion 33a, water is less likely to splash onto the first wire portion 33a.

While example embodiments of the vehicle have been described above, the example embodiments described above are merely examples. Various other example embodiments are possible.

The electrical device to be cooled by coolant is not limited to the controller 55 or the drive motor. The vehicle component is not limited to the battery.

The joints 11A and 11B of the front motor 11 and the joints 12A and 12B of the rear motor 12 may be located leftward of the vehicle center line CL, and a portion of the high-voltage electrical wires 31, a portion of the high-voltage electrical wires 32, the entirety of the high-voltage electrical wires 33, a portion of the high-voltage electrical wires 34, and a portion of the high-voltage electrical wires 35 may be located rightward of the vehicle center line CL.

The water pipe 44 may be located leftward of the central battery 21C, and the central connector 25 may be located rightward of the central battery 21C.

Only selected example embodiments have been chosen to illustrate the present invention. To those skilled in the art, however, it will be apparent from the foregoing disclosure that various changes and modifications can be made herein without departing from the scope of the present invention as defined in the appended claims. Furthermore, the foregoing description of the example embodiments according to the present invention is provided for illustration only, and not for limiting the present invention as defined by the appended claims and their equivalents.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vehicle comprising:
an electrical device;
a high-voltage electrical wire connected to the electrical device; and
a water pipe through which coolant flows to cool the electrical device; wherein
a predetermined portion of the water pipe and the high-voltage electrical wire are spaced apart from each other by at least a first predetermined distance.

2. The vehicle according to claim 1, wherein
the electrical device includes a joint to which the water pipe is detachably connected; and
the joint and the high-voltage electrical wire are spaced apart from each other by at least the first predetermined distance.

3. The vehicle according to claim 1, wherein the first predetermined distance is about 150 mm.

4. The vehicle according to claim 1, wherein the predetermined portion of the water pipe or the joint and the high-voltage electrical wire are separated from each other in a vehicle left-right direction.

5. The vehicle according to claim 1, wherein the predetermined portion of the water pipe or the joint and the high-voltage electrical wire are spaced apart from each other by at least a second predetermined distance in a vehicle left-right direction.

6. The vehicle according to claim 5, wherein
the water pipe includes a first pipe portion extending in a vehicle front-rear direction;
the high-voltage electrical wire includes a first wire portion extending in the vehicle front-rear direction; and
a vehicle component is located between the first pipe portion and the first wire portion in the vehicle left-right direction.

7. The vehicle according to claim 6, wherein the vehicle component includes a battery.

8. The vehicle according to claim 1, wherein the predetermined portion of the water pipe or the joint and the high-voltage electrical wire are spaced apart from each other by at least a second predetermined distance in a vehicle left-right direction and spaced apart from each other by at least a third predetermined distance in a vehicle up-down direction.

9. The vehicle according to claim 1, wherein the predetermined portion of the water pipe or the joint is located below the high-voltage electrical wire in a vehicle up-down direction.

10. The vehicle according to claim 1, wherein at least 60% of the water pipe and at least 60% of the high-voltage electrical wire are spaced apart from each other by at least the first predetermined distance.

11. The vehicle according to claim 1, wherein at least 60% of the water pipe and at least 60% of the high-voltage electrical wire are spaced apart from each other by at least a second predetermined distance in a vehicle left-right direction.

12. The vehicle according to claim 1, wherein the electrical device includes a drive motor.

13. The vehicle according to claim 1, further comprising:
a pair of left and right front wheels; and
a pair of left and right rear wheels; wherein
the electrical device includes a front motor connected to the pair of left and right front wheels to drive the pair of left and right front wheels, and a rear motor connected to the pair of left and right rear wheels to drive the pair of left and right rear wheels;
the front motor includes a first joint detachably connected to the water pipe;
the rear motor includes a second joint detachably connected to the water pipe;
the high-voltage electrical wire is located one of leftward or rightward of a vehicle center line; and
the first joint and the second joint are located on the other one of leftward or rightward of the vehicle center line.

14. The vehicle according to claim 1, wherein
the electrical device includes a central battery that overlaps with a vehicle center line when the vehicle is seen from above, a left-side battery located leftward of the central battery in a vehicle left-right direction, and a right-side battery located rightward of the central battery in the vehicle left-right direction;
the vehicle includes a central connector to connect the central battery and the high-voltage electrical wire;
the water pipe is located one of leftward or rightward of the central battery; and
the central connector is located the other one of leftward or rightward of the central battery.

15. The vehicle according to claim 1, wherein the electrical device includes one or two or more electrical devices.

16. The vehicle according to claim 1, wherein the high-voltage electrical wire includes one or two or more high-voltage electrical wires.

17. The vehicle according to claim 1, wherein the water pipe includes one or two or more water pipes.

18. The vehicle according to claim 1, wherein the electrical device includes one or two or more drive motors.
